(19) United States
(12) Patent Application Publication
(10) Pub. No.: US 2007/0035518 A1
(43) Pub. Date: Feb. 15, 2007

(54) 3D pointing devices

(75) Inventors: Steven Francz, Boonsboro, MD (US); Daniel S. Simpkins, Bethesda, MD (US); Frank J. Wroblewski, Gaithersburg, MD (US); Friedrich Geck, Mt. Airy, MD (US); Negar Moshiri, Bethesda, MD (US); Charles W.K. Gritton, Sterling, VA (US); Arvind Kumar Gupta, Van Nuys, CA (US)

Correspondence Address: POTOMAC PATENT GROUP, PLLC, P. O. BOX 270, FREDERICKSBURG, VA, 22404, US

(73) Assignee: Hillcrest Laboratories, Inc., Rockville, MD (US)

(21) Appl. No.: 11/480,662

(22) Filed: Jul. 3, 2006

Related U.S. Application Data
(60) Provisional application No. 60/696,034, filed on Jul. 1, 2005.

(51) Int. Cl. G09G 5/08

(52) U.S. Cl. 345/163

(57) ABSTRACT

A remote control device, e.g., a 3D pointing device, has a ring-shaped or arcuate-shaped housing and at least one sensor mounted within the housing for sensing movement of said remote control device. The housing is adapted to promote a user's arm, hand and wrist to be substantially in a neutral position when the user is holding the remote control device.

### RELATED APPLICATION

This application is related to, and claims priority from, U.S. Provisional Patent Application Ser. No. 60/696,034, filed on Jul. 1, 2005, the disclosure of which is incorporated here by reference.

### BACKGROUND

The present invention relates 3D pointing devices, as well as systems and methods which include 3D pointing devices.

Technologies associated with the communication of information have evolved rapidly over the last several decades. Television, cellular telephony, the Internet and optical communication techniques (to name just a few things) combine to inundate consumers with available information and entertainment options. Taking television as an example, the last three decades have seen the introduction of cable television service, satellite television service, pay-per-view movies and video-on-demand. Whereas television viewers of the 1960s could typically receive perhaps four or five over-the-air TV channels on their television sets, today's TV watchers have the opportunity to select from hundreds, thousands, and potentially millions of channels of shows and information. Video-on-demand technology, currently used primarily in hotels and the like, provides the potential for in-home entertainment selection from among thousands of movie titles.

The technological ability to provide so much information and content to end users provides both opportunities and challenges to system designers and service providers. One challenge is that while end users typically prefer having more choices rather than fewer, this preference is counterweighted by their desire that the selection process be both fast and simple. Unfortunately, the development of the systems and interfaces by which end users access media items has resulted in selection processes which are neither fast nor simple. Consider again the example of television programs. When television was in its infancy, determining which program to watch was a relatively simple process primarily due to the small number of choices. One would consult a printed guide which was formatted, for example, as series of columns and rows which showed the correspondence between (1) nearby television channels, (2) programs being transmitted on those channels and (3) date and time. The television was tuned to the desired channel by adjusting a tuner knob and the viewer watched the selected program. Later, remote control devices were introduced that permitted viewers to tune the television from a distance. This addition to the user-television interface created the phenomenon known as “channel surfing” whereby a viewer could rapidly view short segments being broadcast on a number of channels to quickly learn what programs were available at any given time.

Despite the fact that the number of channels and amount of viewable content has dramatically increased, the generally available user interface, control device options and frameworks for televisions have not changed much over the last 30 years. Printed guides are still the most prevalent mechanism for conveying programming information. The multiple button remote control with up and down arrows is still the most prevalent channel/content selection mechanism. The reaction of those who design and implement the TV user interface to the increase in available media content has been a straightforward extension of the existing selection procedures and interface objects. Thus, the number of rows in the printed guides has been increased to accommodate more channels. The number of buttons on the remote control devices has been increased to support additional functionality and content handling, e.g., as shown in FIG. 1. However, this approach has significantly increased both the time required for a viewer to review the available information and the complexity of actions required to implement a selection. Arguably, the cumbersome nature of the existing interface has hampered commercial implementation of some services, e.g., video-on-demand, since consumers are resistant to new services that will add complexity to an interface that they view as already too slow and complex.

In addition to increases in bandwidth and content, the user interface bottleneck problem is being exacerbated by the aggregation of technologies. Consumers are reacting positively to having the option of buying integrated systems rather than a number of segregable components. An example of this trend is the combination television/VCR/DVD in which three previously independent components are frequently sold today as an integrated unit. This trend is likely to continue, potentially with an end result that most if not all of the communication devices currently found in the household will be packaged together as an integrated unit, e.g., a television/VCR/DVD/internet access/radio/stereo unit. Even those who continue to buy separate components will likely desire seamless control of, and interworking between, the separate components. With this increased aggregation comes the potential for more complexity in the user interface. For example, when so-called “universal” remote units were introduced, e.g., to combine the functionality of TV remote units and VCR remote units, the number of buttons on these universal remote units was typically more than the number of buttons on either the TV remote unit or VCR remote unit individually. This added number of buttons and functionality makes it very difficult to control anything but the simplest aspects of a TV or VCR without hunting for exactly the right button on the remote. Many times, these universal remotes do not provide enough buttons to access many levels of control or features unique to certain TVs. In these cases, the original device remote unit is still needed, and the original hassle of handling multiple remotes remains due to user interface issues arising from the complexity of aggregation. Some remote units have addressed this problem by adding “soft” buttons that can be programmed with the expert commands. These soft buttons sometimes have accompanying LCD displays to indicate their action. These too have the flaw that they are difficult to use without looking away from the TV to the remote control. Yet another flaw in these remote units is the use of modes in an attempt to reduce the number of buttons. In these “moded” universal remote units, a special button exists to select whether the remote should communicate with the TV, DVD player, cable set-top box, VCR, etc. This causes many usability issues including sending commands to the wrong device, forcing the user to look at the remote to make sure that it is in the right mode, and it does not provide any simplification to the integration of multiple devices. The most advanced of these universal remote units provide some integration by allowing the user to program sequences of commands to multiple devices into the remote. This is such a difficult task that many users hire professional installers to program their universal remote units.

A relatively new type of remote control devices are sometimes called “3D pointing devices.” The phrase “3D pointing” is used in this specification to refer to the ability of an input device to move in three (or more) dimensions in the air in front of, e.g., a display screen, and the corresponding ability of the user interface to translate those motions directly into user interface commands, e.g., movement of a cursor on the display screen. The transfer of data between the 3D pointing device and another device may be performed wirelessly or via a wire connecting the 3D pointing device to another device. Thus “3D pointing” differs from, for example, conventional computer mouse pointing techniques which use a surface, e.g., a desk surface or mousepad, as a proxy surface from which relative movement of the mouse is translated into cursor movement on the computer display screen. An example of a 3D pointing device can be found in U.S. Pat. No. 5,440,326.

The '326 patent describes, among other things, a vertical gyroscope adapted for use as a pointing device for controlling the position of a cursor on the display of a computer. A motor at the core of the gyroscope is suspended by two pairs of orthogonal gimbals from a hand-held controller device and nominally oriented with its spin axis vertical by a pendulous device. Electro-optical shaft angle encoders sense the orientation of a hand-held controller device as it is manipulated by a user and the resulting electrical output is converted into a format usable by a computer to control the movement of a cursor on the screen of the computer display. However, the '326 patent does not consider that 3D pointing devices can be used differently than conventional remote control devices.

Accordingly, it would be desirable to provide 3D pointers which are designed taking into account the use cases, ergonomics, anthropometrics and the like.

### SUMMARY

According to one exemplary embodiment of the present invention, a remote control device includes a ring-shaped housing and at least one sensor mounted within the ring-shaped housing for sensing movement of said remote control device.

According to another exemplary embodiment of the present invention, a remote control device includes an arcuate-shaped housing and at least one sensor mounted within the arcuate-shaped housing for sensing movement of said remote control device.

### BRIEF DESCRIPTION OF THE DRAWINGS

The accompanying drawings illustrate exemplary embodiments of the present invention, wherein:

FIG. 1 depicts a conventional remote control unit for an entertainment system;

FIG. 2 illustrates a person sitting holding a ring-shaped 3D pointing device according to an exemplary embodiment of the present invention;

FIGS. 3A-3B illustrate four major movements for the hand and wrist;

FIG. 4A shows a side view of a user holding a conventional two-button mouse with scroll wheel;

FIG. 4B shows a side view of a user holding a ring-shaped 3D pointing device according to an exemplary embodiment of the present invention;

FIG. 4C illustrates a top view of a user holding a ring-shaped 3D pointing device according to an exemplary embodiment of the present invention;

FIG. 4D illustrates how to measure maximum grip size;

FIG. 4E shows maximum grip size for different ages, sex and percentiles;

FIG. 5 shows a 3D pointing device and a display according to an exemplary embodiment of the present invention;

FIG. 6A shows the 3D pointing device having a grip region with varyingly sized cross-sections according to an exemplary embodiment of the present invention;

FIG. 6B shows the smallest cross-section of the 3D pointing device of FIG. 6A according to an exemplary embodiment of the present invention;

FIG. 6C shows the largest cross-section of the 3D pointing device of FIG. 6A according to an exemplary embodiment of the present invention;

FIG. 7 depicts balance and weighting aspects of a ring-shaped 3D pointing device according to an exemplary embodiment of the present invention;

FIGS. 8A-8G illustrate an arcuate-shaped 3D pointing device according to an exemplary embodiment of the present invention;

FIGS. 9A-9G illustrate an arcuate-shaped 3D pointing device according to another exemplary embodiment of the present invention; and

FIG. 10 depicts a hardware architecture of a 3D pointing device according to an exemplary embodiment of the present invention.

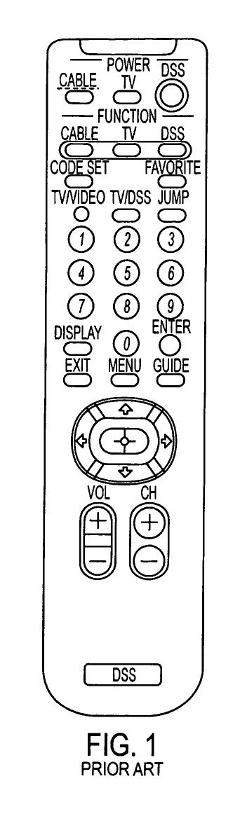

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims.

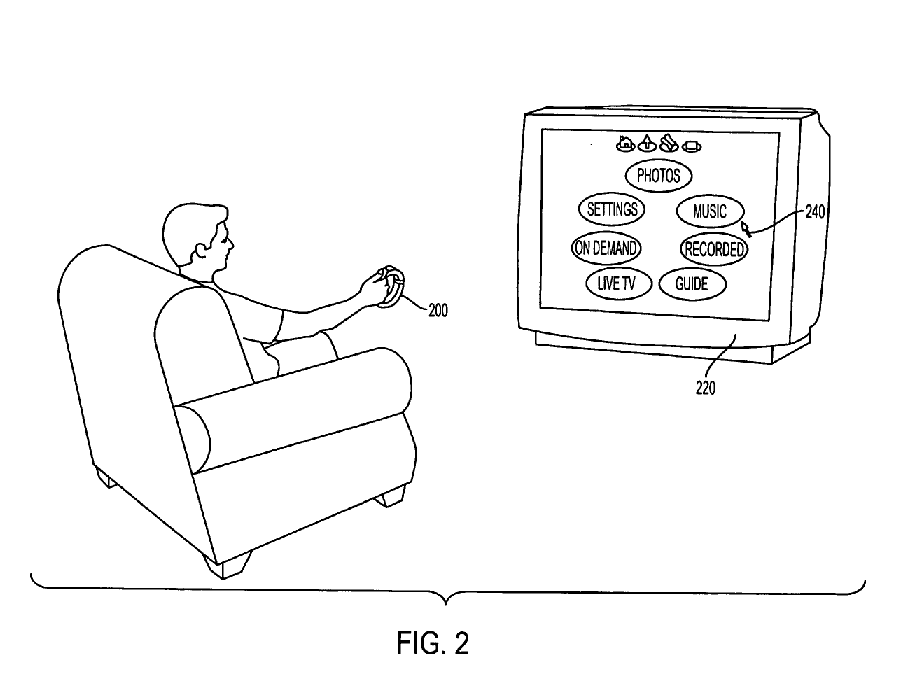

In order to provide some context for this discussion, consider an exemplary environment within which 3D pointing devices according to exemplary embodiments of the present invention may be used. For example, as shown in FIG. 2, a person may be sitting (or standing) in front of a television 220, holding a 3D pointing device 200 in her or his hand. The 3D pointing device 200 can be used to provide inputs, e.g., commands, to a user interface displayed on the television 220, to select various media items for display. The 3D pointing device 200 may be used in an unsupported manner, i.e., it may spend at least some period of time being moved in the air by a user relative to the television 220 to point at various user interface objects displayed on the television.

According to some exemplary embodiments of the present invention, 3D pointing device 200 can have a ring-shaped housing or body as shown in FIG. 2 and described in more detail below. The 3D pointing device 200 may or may not have one or more buttons, scroll wheels, or other user-actuable control elements for providing user input. Regardless of the number and type of user-actuable control elements which are provided on 3D pointing device 200, movement of the device 200 (e.g., in three or more dimensions) is sensed and provided as user input. For example, as the 3D pointing device 200 moves between different positions, that movement is detected by one or more sensors (not shown) within 3D pointing device 200 and transmitted to the television 220 (or associated system component, e.g., a set-top box (not shown)). Movement of the 3D pointing device 200 can, for example, be translated into movement of a cursor 240 displayed on the television 220 and which is used to interact with a user interface. Various details associated with various sensing technologies which can be used in 3D pointing device 200, user interfaces, etc., are described below and in several incorporated-by-reference patent applications.

Given the foregoing general usages of 3D pointing devices according to exemplary embodiments of the present invention, a number of different factors should be considered either individually or together in the development of a 3D hand held device. For example, the housing of the device should promote grasping and holding the 3D pointing device in one hand, the grip should be optimized to anthropometric size data for the targeted user population, the device should be useable in either the left or right hand, user-actuable control elements (if any) should be disposed on the housing at a position to enable actuation while moving the device in the air, and the device weight should feel balanced when holding the device. Additionally, the housing and/or grip of 3D pointing devices according to exemplary embodiments of the present invention should be designed to facilitate low fatigue manipulation of the device taking into account wrist, hand and arm positions while holding the device in, e.g., the afore-described unsupported pointing applications. These factors, and their impact on 3D pointing device design according to exemplary embodiments of the present invention, are described in detail below.

Grip

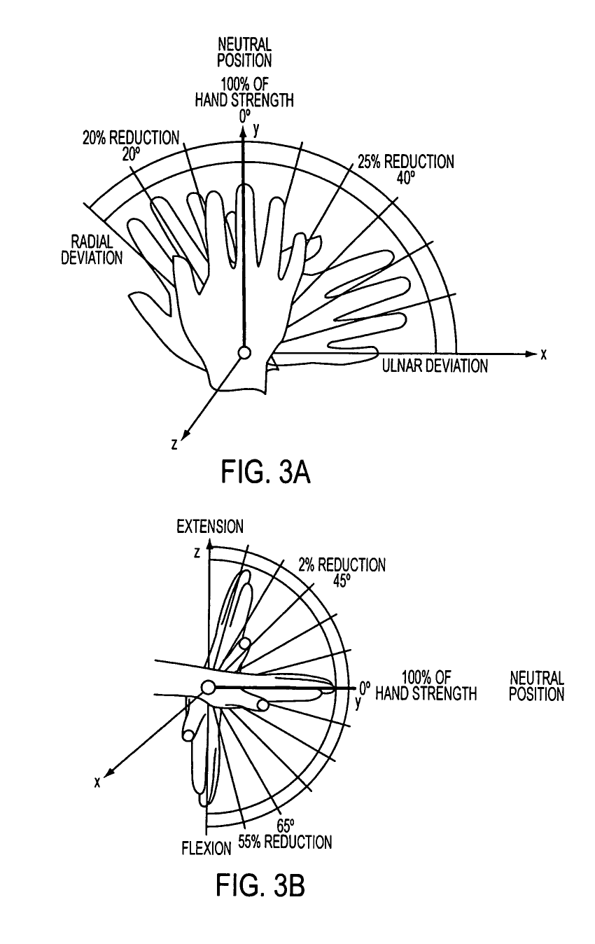

According to exemplary embodiments of the present invention, 3D pointing devices are designed in such a way as to encourage a user to grip the 3D pointing devices in a manner which minimizes any stress associated with holding the device by maximizing the user's strength. Consider that the percentage of a user's strength available for holding a remote control device is related to the angle of rotation of the user's hand, arm and wrist. For example, as shown in FIG. 3A, as a user's wrist is rotated to the right (ulnar deviation) or left (radial deviation) along the z-axis, his or her hand strength decreases relative to that available in a neutral (0°) position. Likewise, as the user's wrist rotates “up” or “down” about the x-axis relative to a neutral (0°) position, his or her hand strength also declines (see FIG. 3B). Thus, to reduce any fatigue associated with holding a 3D pointing device, it would be desirable to design such devices in such a way that users are likely to hold the device in a position which is as close to the neutral position as possible.

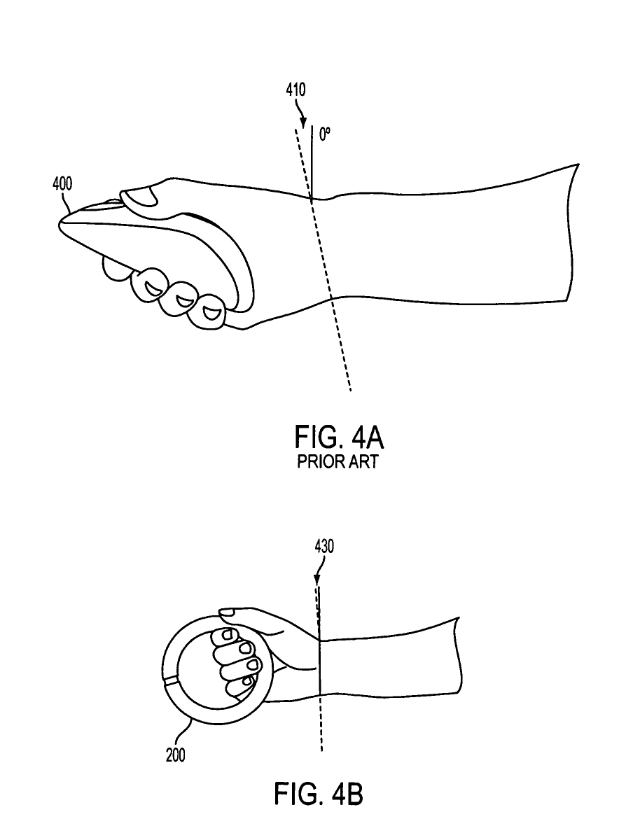

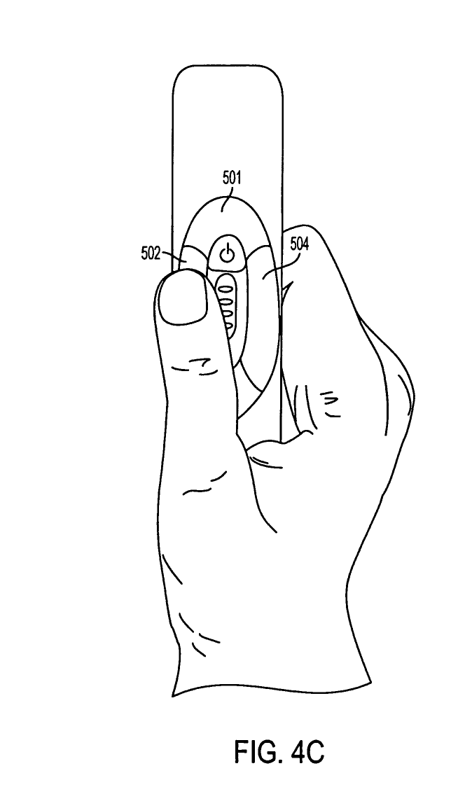

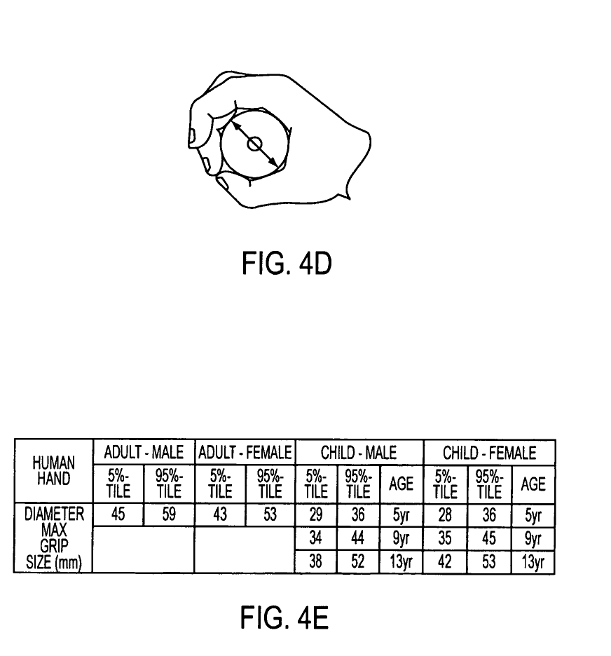

In this regard, consider first how a user might naturally hold a conventionally designed computer mouse in an unsupported, 3D application. An illustration of this use is shown in FIG. 4A. Therein it can be seen that a natural (right-handed) grip of the computer mouse 400 places the user's thumb over the control area on the top surface of the computer mouse 400, with the remaining fingers cradling the computer mouse 400 underneath the device. With this grip the user can actuate either button or the scroll-wheel using his or her thumb without changing his or her grip on the computer mouse 400. However, holding the computer mouse 400 in this manner also introduces an ulnar deviation since the user's wrist is rotated by an angle 410 shown in FIG. 4A. The ulnar deviation in the illustrated example was measured to be on the order of 15 degrees. This amount of ulnar deviation, encouraged by conventional mouse designs, may or may not be significant for conventional, supported mouse pointing applications, e.g., where the computer mouse 400 typically rests on a desk or table. However, these (and other considerations) are relevant for, among other things, providing a 3D pointing device which can be held comfortably by a user who is moving the device in three (or more) dimensions in front of a display screen, potentially for extended periods of time.

Thus, according to an exemplary embodiment of the present invention, a “power grip” design is provided for 3D pointing devices, which design takes into account hand, arm and wrist positions, as well as other fatigue-inducing and ease-of-use considerations. In this specification, the phrase “power grip” refers to a grip that minimizes a user's overall fatigue by keeping the wrist in an approximately neutral position. An exemplary power grip resulting in a desirable hand, arm and wrist position is displayed in FIG. 4B. A user holding the ring-shaped 3D pointing device 200 in a natural way will typically hold the device in substantially the manner illustrated, resulting in low fatigue. Design features of the ring-shaped 3D pointing device 200, e.g., the relative size, shape and/or positioning of the housing, grip and button (if any), encourage the user to hold the 3D pointing device 200 in a power grip. The synergy of these design features is described in more detail below. Thus, for example, a user holding the ring-shaped 3D pointing device 200 will typically hold the device in such a way that his or her wrist position will exhibit an ulnar deviation 430 of e.g., about +1° or less as shown in FIG. 4B. The device should promote a “normal use” position with the wrist in approximately the neutral position, i.e., nominally within the range of +8 degrees to −4 degrees of ulnar deviation relative to the neutral position. This range is associated with the position which will cause the least fatigue.

Various features associated with the ring-shaped housing of some of the exemplary embodiments of the present invention encourage users to grip the device with a power grip, e.g., ergonomics, anthropometrics, aesthetics, architectural design and internal component placement. One anthropometric element of particular interest for a hand held remote control device is grip size. Maximum grip size can be defined, for example, as the largest cylindrical shape that can be grasped while touching the middle finger to the thumb as shown in FIG. 4C. In order to determine a suitable shape size for the hand held remote control device 200, both maximum and minimum grip sizes should be considered. Exemplary grip size data is shown in FIG. 4D for different ages, sex and percentiles. Additional data such as finger length and finger width can also be considered useful when determining the locations and sizes of control areas, such as buttons, scroll wheels, etc., on the 3D pointing device 200.

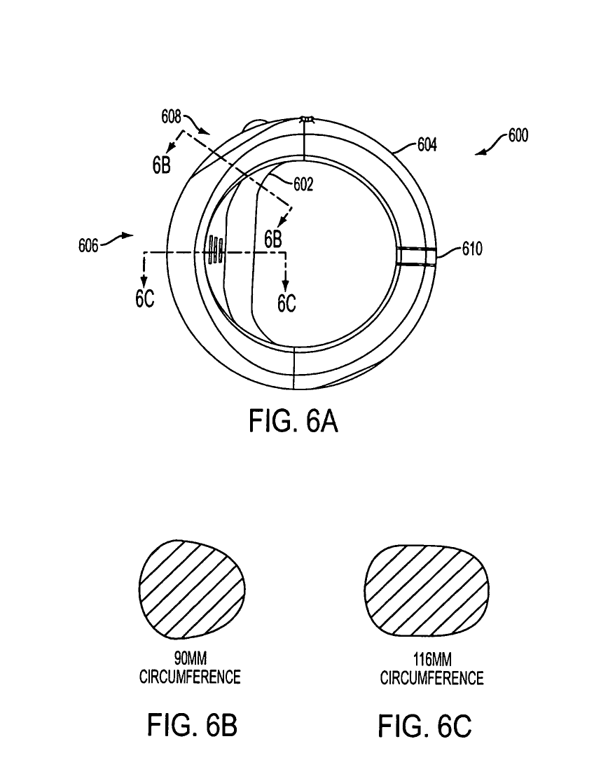

According to various exemplary embodiments of the present invention, the grip region of a 3D pointing device 200 can have a variable grip size to accommodate user's with smaller or larger hands. In this specification, grip region thicknesses are alternately described by their diameter or by their circumference. Note that in this context, since cross-sections of the grip region may be circular, elliptical (oval) or quasi-elliptical, the “diameter” of a grip region refers to the diameter that has an equivalent circumference to the cross-sectional shape of the grip. For example, according to one exemplary embodiment, a cross section of the grip region can have a diameter (or, alternately, a circumference equivalent) with a value ranging between 28 mm (88 mm circumference) and 59 mm (185 mm circumference). In order to fit within the 5th %-tile for a 5 year old male, the diameter of 29 mm is equivalent to a circumference of 91 mm. A more specific, but also purely illustrative example, is shown in the cross sections of FIGS. 6B and 6C for a grip region having a minimum size of 90 mm (circumference) and a maximum size of 116 mm (circumference). This illustrative example shows possible sizes that address most of the ranges shown for adults and children noted in the table of FIG. 4E. However those skilled in the art will appreciate that other grip region, cross-sectional sizes may be used according to other exemplary embodiments of the present invention. Moreover, the present invention is not limited to grip regions having variable sizes.

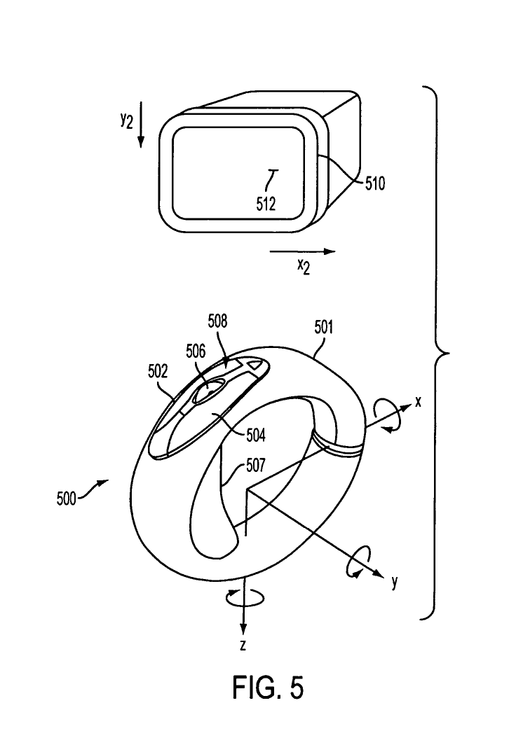

To provide some additional context for this discussion of grip sizes, an exemplary ring-shaped, 3D pointing device 500 designed in accordance with the present invention is depicted in FIG. 5. Therein, user movement of the 3D pointing device can be defined, for example, in terms of a combination of x-axis attitude (roll), y-axis elevation (pitch) and/or z-axis heading (yaw) motion of the 3D pointing device 500. In addition, some exemplary embodiments of the present invention can also measure linear movement of the 3D pointing device 500 along the x, y, and z axes to generate cursor movement or other user interface commands. In the exemplary embodiment of FIG. 5, the 3D pointing device 500 includes a ring-shaped housing 501, two buttons 502 and 504 as well as a scroll wheel 506 and grip 507, although other exemplary embodiments will include other physical configurations. The region 508 which includes the two buttons 502 and 504 and scroll wheel 506 is referred to herein as the “control area” 508, which is disposed on an outer portion of the ring-shaped housing 501.

As mentioned above with respect to FIG. 2, and according to exemplary embodiments of the present invention, it is anticipated that 3D pointing devices 500 will be held by a user in front of a display 510 and that motion of the 3D pointing device 500 will be translated by the 3D pointing device into output which is usable to interact with the information displayed on display 510, e.g., to move the cursor 512 on the display 510. For example, rotation of the 3D pointing device 500 about the y-axis can be sensed by the 3D pointing device 500, e.g., using one or more inertial sensors (not shown) disposed within the ring-shaped housing 501, and translated into an output usable by the system to move cursor 512 along the Y₂ axis of the display 510. Likewise, rotation of the 3D pointing device 500 about the z-axis can be sensed by the 3D pointing device 500 and translated into an output usable by the system to move cursor 512 along the x₂ axis of the display 510. It will be appreciated that the output of 3D pointing device 500 can be used to interact with the display 510 (e.g., a television or computer monitor) in a number of ways other than (or in addition to) cursor movement, for example it can control cursor fading, volume or media transport (play, pause, fast-forward and rewind), zoom in or zoom out on a particular region of a display. A cursor may or may not be visible. Similarly, rotation of the 3D pointing device 600 sensed about the x-axis of 3D pointing device 600 can be used in addition to, or as an alternative to, y-axis and/or z-axis rotation to provide input to a user interface.

Returning to the power grip design consideration of grip size, consider the exemplary embodiment of FIGS. 6A-6C. Therein it should be noted that the grip region, e.g., the portions of the 3D pointing device 600 which are intended to be gripped by a user's hand, include two elements which contribute to the grip size: the grip 602 and the portion 606 of the ring-shaped housing 604 to which the grip 602 is attached. According to this exemplary embodiment of the present invention, the grip region supports a wide range of anthropometric sizes for a wide range of users by providing a transition of the grip size from a smaller grip circumference (see e.g., FIG. 6B) to a larger grip circumference (see, e.g., FIG. 6C). The smaller grip circumference is located closer to the control area 608 to enable a smaller-handed user to comfortably hold the 3D pointing device 600 in a power grip while allowing them to easily reach the controls. Similarly, larger-handed users will grip the 3D pointing device 600 further away from the control area 608 in the grip region around a larger circumference, but their longer fingers will naturally be located proximate the control area 608 for easy use of the device. Typically, a user will position his or her hand on the hand grip portion such that his or her thumb can be used to actuate the button(s) located on the top of the device. According to this purely exemplary embodiment, at the smallest grip region cross-section (FIG. 6B) of the ring-shaped hand held remote control device 600, the circumference of 90 mm is equivalent to a diameter of approximately 29 mm, and at the largest handle cross-section (FIG. 6C), the circumference is equivalent to a diameter of approximately 37 mm, although those skilled in the art will appreciate that other values, including those described above, may be used.

Also shown in FIG. 6A is an optional light pipe 610 which can emit light when the 3D pointing device 600 is turned on. The optional light pipe 610 is disposed on the ring-shaped body 604 across from the grip 602 and provides a user with a pointing “guide”. Depending upon the internal electrical components/sensor package employed within the 3D pointing device 600 (an example of which is described below), the light pipe 610 may be entirely aesthetic since the pointing function performed by the device 600 may be completely independent of device orientation.

Weight and Balance

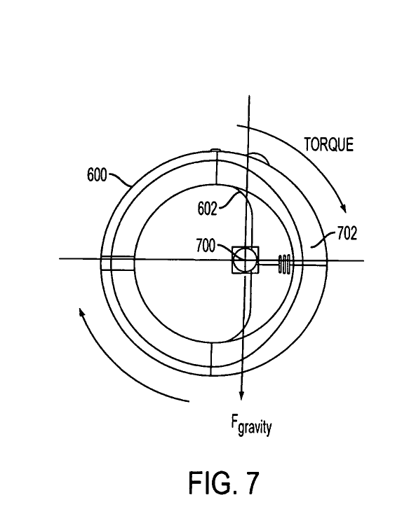

In addition to size and shape, weight and balance of 3D pointing devices according to exemplary embodiments of the present invention should also be considered. According to exemplary embodiments of the present invention, 3D pointing devices 600 can be weighted (have their weight elements distributed) in a manner that produces a torque around the index finger by positioning the y-axis center of gravity 700 of the device proximate an outer surface of a center portion of the grip 602 near a geometric center of the device, as shown in FIG. 7. This also facilitates both left-handed and right-handed use of the device. The closer that the center of gravity is to the palm or wrist of the user as she or he holds the device in a power grip, the lighter the device will be perceived to be by the user. For example, the batteries 802, which account for approximately 30 percent of the unit's weight in this example, can be positioned in the area of the grip region where the middle of a user's palm will rest, centered over the middle finger. This placement allows the user's hand to keep the weight close to the grip and reduce the possible torque and added force if the weight were extended away from the palm area. Similarly, along the x-axis, the weight of the 3D pointing device 600 should be distributed as evenly as possible to prevent a top or bottom heavy feel which might require a user to use a more forceful grip to maintain the neutral position. According to an exemplary embodiment the overall unit weight can be six ounces or less.

With the weighting and balancing scheme described herein, the ring-shaped housing 601 can rest easily (“hang”) on a user's index finger as an alternative to the user holding the device in a power grip. This usage of the device can be facilitated by providing a recess or depression on an inner side of the housing 601, e.g., by curving the portion of the grip as demonstrated by the radius numeral 602.

Control Area

As mentioned earlier, the control area 508, 608 includes one or more user-actuable control elements, e.g., buttons, a scroll-wheel (which can also be a button), and the like, which enable the user to input data in addition to the pointing information gathered by the sensor(s) internal to the 3D pointing device 600. These controls can be mapped to various functions based upon the particular application of the 3D pointing device 600, e.g., back, forward, select, up, down, zoom-in, zoom-out, scroll, etc. The user-actuable control elements within the control area 508, 608 should be located on an outer portion of the ring-sized housing 501, 604 and sized to fit the range of hand sizes of the intended user population. This enables the controls to be positioned where the user's thumb naturally rests on the device when the device is maintaining the neutral position of the hand, wrist and arm.

The controls are preferably symmetrically positioned within the control area to facilitate operation by either right or left handed users. Thus the function of the control elements within the control area may also be configurable. For example, if the control area includes two buttons and a scroll wheel, one button could be associated with a “back” function and one button could be associated with a “select” function. The designation of either the left-hand button 502 or the right-hand button 504 as performing the “back” function in a user interface which is in communication with the 3D pointing device 500 is configurable to accommodate user preference. For example, a default configuration could provide that the left-hand button 502, i.e., the position within the control area 508 where the thumb of a right-handed user would naturally rest (see FIG. 4C), is associated with the most frequently used interface command for right-handed users, e.g., a “select” function. Conversely, for left-handed users, the default configuration could associate the right-hand button 504 with the most frequently used interface command. Preferably all of the user-actuable control elements that are used during normal operation of the 3D pointing device will be accessible to the user without the user re-gripping or re-positioning the device, e.g., as seen in FIG. 4C and FIG. 5.

Alternate Housing Shapes

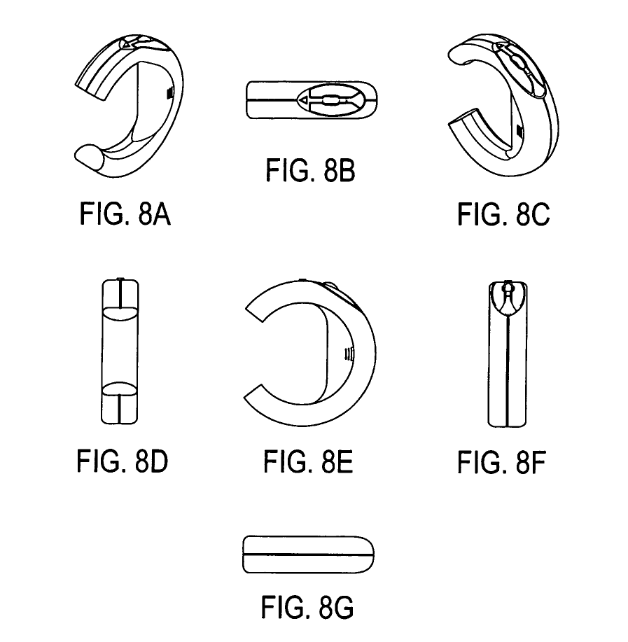

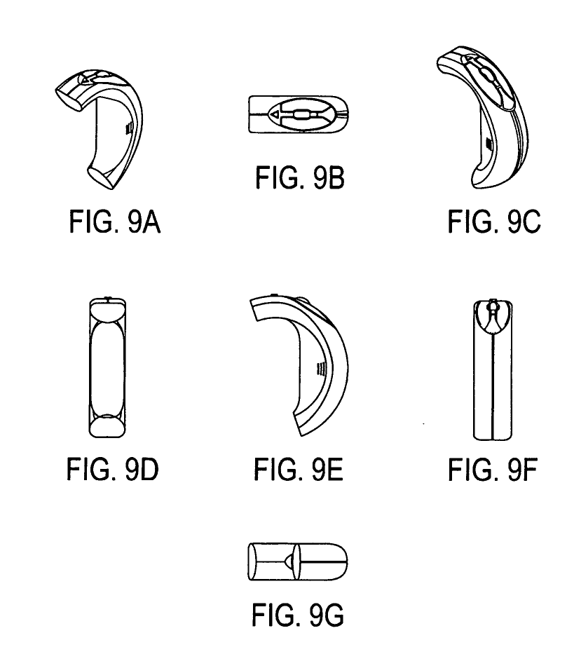

The foregoing exemplary embodiments of the present invention depict 3D pointing devices which have a closed, ring-shaped housing or body. However the present invention is not so limited. According to other exemplary embodiments of the present invention, the shape of the housing need not be closed, e.g., it can be C-shaped, or semi-circular as shown in FIGS. 8A-8G and 9A-9G, respectively or rectangular, triangular, etc. As used in this specification, the phrase “ring-shaped housing” refers to housings which are completely closed, whereas the phrase “arcuate-shaped housing” refers to housings which have two ends. Ring-shaped housings may be circular, elliptical or any other shape. Arcuate-shaped housings may be C-shaped, semi-circular, a portion of an ellipse or any other shape.

Regardless of the housing shape, 3D pointing devices according to exemplary embodiments of the present invention will include some or all of the other ergonomic, anthropometric, aesthetic, architectural design and internal component placement features described above with respect to those exemplary embodiments which include a ring-shaped housing. For example, as seen in FIGS. 8A-8G and 9A-9G, the grip region of these 3D pointing devices have a varying thickness to accommodate users with smaller or large hands, as described above. For a purely illustrative example, these arcuate-shaped housings provide a smallest grip region cross-section circumference equivalent to a diameter of approximately 30 mm, and a largest grip cross-section circumference equivalent to a diameter of approximately 45 mm.

Internal Sensors and Other Components

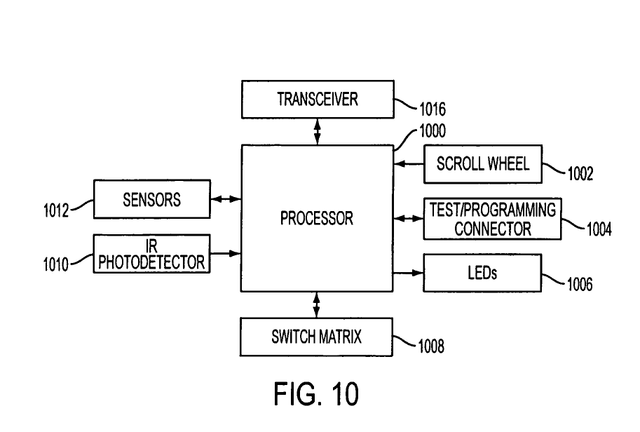

FIG. 10 illustrates a high level, exemplary hardware architecture of circuitry that resides inside the ring-shaped housing 601 or arcuate-shaped housings of FIGS. 8A-9G. Therein, a processor 1000 communicates with other elements of the 3D pointing device 600 including a scroll wheel 1002, test/programming connector 1004, LEDs 1006, switch matrix 1008, IR LED and photodetector 1010, sensors 1012, and transceiver 1016. The scroll wheel 1002 is an optional input component which enables a user to provide input to the interface by rotating the scroll wheel 1002 clockwise or counterclockwise. Test/programming connector 1004 provides the programming and debugging interface to the processor. LEDs 1006 provide visual feedback to a user, for example, when a button is pressed. Switch matrix 1008 receives inputs, e.g., indications that a button on the 3D pointing device 800 has been depressed or released, that are then passed on to processor 1000. The optional IR LED and photodetector 1010 can be provided to enable the exemplary 3D pointing device to send IR codes and learn IR codes from other remote controls. Sensors 1012 provide readings to processor 1000 regarding, e.g., the y-axis and z-axis for the 3D pointing device as described above. Transceiver 1016 is used to communicate information to and from 3D pointing device 600, e.g., to a system controller or to a processor associated with a computer. The transceiver 1016 can be a wireless transceiver, e.g., operating in accordance with the for example the Bluetooth standards or other RF technologies for short-range wireless communication or an infrared transceiver. Alternatively, 3D pointing device 600 can communicate with systems via a wireline connection. Note that this architecture is purely exemplary and the 3D pointing devices described and claimed herein can be used with different architectures and different sensor types, e.g., non-inertial sensors such as magnetometers.

For the interested reader, many more details regarding exemplary hardware and software associated with exemplary internal functionality of 3D pointing device 600 can be found in U.S. patent applications Ser. Nos. 11/119,987, 11/119,719, 11/119,688 and 11/119,663 entitled “Methods and Devices for Removing Unintentional Movement in 3D Pointing Devices”, “3D Pointing Devices with Tilt Compensation and Improved Usability”, “Methods and Devices for Identifying Users Based on Tremor”, and “3D Pointing Devices and Methods”, all of which were filed on May 2, 2005 and all of which are incorporated here by reference.

Additionally, 3D pointing devices according to exemplary embodiments of the present invention can be used in conjunction with zoomable graphical user interfaces. For more information regarding zoomable graphical user interfaces the interested reader is directed to U.S. patent application Ser. No. 10/768,432, filed on Jan. 30, 2004, entitled “A Control Framework with a Zoomable Graphical User Interface for Organizing, Selecting and Launching Media Items”, the disclosure of which is incorporated here by reference.

The above-described exemplary embodiments are intended to be illustrative in all respects, rather than restrictive, of the present invention. Thus the present invention is capable of many variations in detailed implementation that can be derived from the description contained herein by a person skilled in the art. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

1. A remote control device comprising:
a hand-held, ring-shaped housing; and
at least one initial sensor mounted within said ring-shaped housing for sensing movement of said remote control device.

2. The remote control device of claim 1, wherein said ring-shaped housing is adapted to promote a user's arm, hand and wrist to be substantially in a neutral position when the user is holding the remote control device.

3. The remote control device of claim 1 further comprising:
a grip attached to an inner side of a portion of said ring-shaped housing.

4. The remote control device of claim 3, wherein said grip in conjunction with said portion of said ring-shaped housing together comprise a grip region, said grip region having at least one predetermined circumference and at least one predetermined diameter.

5. The remote control device of claim 4, wherein said at least one predetermined circumference equivalent to a diameter having a maximum value ranging between 28 mm and 59 mm.

6. The remote control device of claim 4, wherein said at least one predetermined diameter or alternate shape having a radii or blended surface of a minimum value of 12 mm.

7. The remote control device of claim 4, wherein said at least one predetermined circumference varies along at least a portion of said grip region.

8. The remote control device of claim 7, wherein said at least one predetermined circumference varies from a minimum circumference in the range of 87-100 mm to a maximum circumference in the range of 115-150 mm.

9. The remote control device of claim 8, wherein said minimum circumference is 90 mm and said maximum circumference is 130 mm.

10. The remote control device of claim 4, wherein said grip region has a cross-sectional area which is one of circular, elliptical or substantially elliptical in shape.

11. The remote control device of claim 1, further comprising:
a control area positioned on an outer portion of said ring-shaped housing, said control area including at least one user-actuable control element.

12. The remote control device of claim 11, wherein said at least one user-actuable control element includes two buttons and a scroll wheel.

13. The remote control device of claim 11, wherein said outer portion of said ring-shaped housing is located proximate to a grip portion of said remote control device.

14. The remote control device of claim 13, wherein said location of said outer portion of said ring-shaped housing relative to said grip portion of said remote control device enables a user's digits to naturally rest proximate said at least one user-actuable control element when said user holds said remote control device via said grip portion.

15. The remote control device of claim 1, wherein elements of said remote control device are distributed around said ring-shaped housing such that a center of gravity of said remote control device is proximate a grip region of said remote control device.

16. The remote control device of claim 1, wherein the remote control device is a 3D pointing device.

17-32. (canceled)
